(19) United States
(12) Patent Application Publication
(10) Pub. No.: US 2004/0200710 A1
(43) Pub. Date: Oct. 14, 2004

(54) Key switch device and portable electronic device having the same

(76) Inventors: Yasuo Takada, Suwon (KR); Chul Gi Min, Suwon (KR); Jeong Hun Lee, Suwon (KR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/464,799

(22) Filed: Jun. 19, 2003

(30) Foreign Application Priority Data
Apr. 14, 2003 (KR) 2003-23511

(51) Int. Cl. H01H 13/70

(52) U.S. Cl. 200/344

(57) ABSTRACT

A key switch device comprising a mounting member made separate from a support plate or backing board. The key switch device comprises first and second link members are cross-linked with each other to act like scissors; the key top having receiver portions formed in an underside thereof for movably or pivotably receiving upper shaft pairs each formed at upper ends of each of the first and second link members; a support plate disposed under the key top and having a plurality of through holes in predetermined positions; a membrane member disposed on the support plate under the key top, the membrane member having a contact point for contacting an elastic switch as the elastic switch is pressed down by the key top and openings formed around the through holes in the support plate to expose the through holes; and a mounting member separate from the support plate, the mounting member including fixing portions for movably or pivotably fixing lower shaft pairs each formed at lower ends of the each link member and fastening portions fixedly fastened with an underside of the support plate via the through holes in the support plate. The invention imparts a simple structure to the support plate.

### BACKGROUND OF THE INVENTION

1. Field of the Invention

The present invention relates to a key switch device, in particular, which comprises a mounting member made separate from a support plate or backing board, in which the mounting member serves to mount a guide member disposed under a key top for guiding vertical movement of the key top.

The present invention also relates to a portable electronic device comprising the above key switch device of the invention.

2. Description of the Related Art

In general, a portable electronic device such as a notebook computer uses a keyboard comprising a number of key switch devices in use for input operation. Each key switch device includes a guide member comprising a pair of link members which are cross-linked with each other in a mutually movable fashion. The guide member guides vertical movement of a key top and also cooperates with the key top to perform switching operation.

Such a key switch device is known from a number of documents, and an example thereof is disclosed in Japanese Patent Publication No.2924427 entitled “Key Switch Device”, published on May 7, 1999. The key switch device in the above document will be described briefly in reference to FIG. 1.

In a key switch device shown in FIG. 1, two mounting members 102 and 103 are vertically projected downward from the underside of a key top 101, and vertical movement of the key top 101 results in switching operation of a rubber spring or a switching member 131. A guide member 106 comprising two link members 107 and 108, which are cross-linked with each other in a mutually movable fashion, is disposed between the key top 101 and the switching member 131. The link member 107 has formed mounting pins 115 at both lower ends thereof, the link member 108 has formed mounting pins 121 at both lower ends thereof. A flexible circuit board 130 is disposed under the switching member 131. The flexible circuit board 130 overlies a support plate 125, which has formed mounting pieces or mounting projections 135 and 136 corresponding to the mounting members 102 and 103.

The support plate 125 is made of metal, and the mounting projections 135 and 136 are formed by processing the support plate 125. Also, the flexible circuit board 130 has formed through holes (not shown) corresponding to the mounting projections 135 and 136.

However, the foregoing key switch device has drawbacks as follows:

Because the mounting projections or mounting projections for receiving the mounting pins are integrally projected from the metal support plate, it is difficult to form the mounting projections with a high degree of precision necessary for the key switch device if the support plate is made of a hard metal. Therefore, the support plate is generally made of flexible material such as aluminum so that the mounting projections can be readily formed at a high degree of precision. However, because aluminum is poor in strength, the mounting projections tend to be depressed or leaned laterally even under small pressure. Further, the mounting projections may be broken under larger pressure. This disables the whole support plate.

In actual application to a keyboard, a number of key switch devices are mounted on a common support plate, and an array of mounting projections corresponding to the respective key switch devices are projected from the support plate. Therefore, the operation of forming the mounting projections becomes more complicated in proportion to the number of the mounting projections. Also, damage of a single mounting projection ruins the whole support plate, and the support plate should be substituted by a new one.

Therefore, the keyboard requires a novel mounting projection structure, by which the whole support plate is not substituted by a new one even if some of mounting projections are damaged. Furthermore, it will be more desirable that the mounting projections be made of relatively high strength material.

### SUMMARY OF THE INVENTION

Accordingly, it is an object of the present invention to provide a key switch device which comprises a mounting member made separate from a support plate or backing board, in which the mounting member serves to mount guide members disposed under a key top for guiding vertical movement of the key top, in order to facilitate a fabrication process of the key switch device.

It is another object of the invention to provide a key switch device which comprises a mounting member made separate from a support plate in order to obtain a more secure structure.

It is further another object of the invention to provide a key switch device which comprises a mounting member for maintaining a rubber switch in position in order to omit any additional component for maintaining the rubber switch in position.

It is yet another object of the invention to provide a portable electronic device comprising any of the above-described key switch devices.

According to an aspect of the invention, there is provided a key switch device for switching a signal as a key top is pressed down, comprising: first and second link members which are cross-linked with each other to act like scissors; the key top having receiver portions formed in an underside thereof for movably or pivotably receiving upper shaft pairs each formed at upper ends of each of the first and second link members; a support plate disposed under the key top and having a plurality of through holes in predetermined positions; a membrane member disposed on the support plate under the key top, the membrane member having a contact point for contacting an elastic switch as the elastic switch is pressed down by the key top and openings formed around the through holes in the support plate to expose the through holes; and a mounting member separate from the support plate, the mounting member including fixing portions for movably or pivotably fixing lower shaft pairs each formed at lower ends of the each link member and fastening portions fixedly fastened with an underside of the support plate via the through holes in the support plate.

According to another aspect of the invention, there is provided a key switch device for switching a signal as a key top is pressed down, comprising: first and second link members which are cross-linked with each other to act like scissors; the key top having receiver portions formed in an underside thereof for movably or pivotably receiving upper shaft pairs each formed at upper ends of each of the first and second link members; a support plate disposed under the key top; a membrane member disposed on the support plate under the key top and having a contact point; an elastic switch shaped as a conical frustum, and when pressed down by the key top, contacting by a portion thereof the contact point in the membrane member; and a mounting member separate from the support plate, the mounting member including fixing portions for movably or pivotably fixing lower shaft pairs each formed at lower ends of the each link member, fastening portions fixedly fastened with the support plate, and means for maintaining the elastic switch in position, wherein the maintaining means has a central opening for supporting a lower outer periphery of the elastic switch.

According to yet another aspect of the invention, there is provided portable electronic device comprising: a CPU, a storage unit for storing a plurality of programs, a board mounted with a plurality of components for processing operations according to the programs, a keyboard, a liquid crystal display unit, and a power supply, wherein the keyboard includes a plurality of key switch devices as set forth.

### BRIEF DESCRIPTION OF THE DRAWINGS

In the accompanying drawings,

FIG. 1 is a partial sectional view of a key switch device of the prior art;

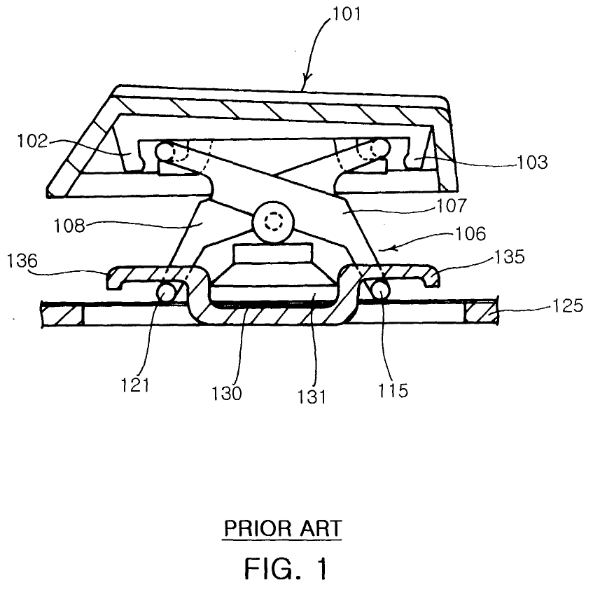

FIG. 2 is a partially exploded perspective view of a keyboard having key switch devices of the invention;

FIG. 3 is a partially broken perspective view of a key switch device of the invention;

FIG. 4 is an exploded perspective view of the key switch device in FIG. 3;

FIG. 5 is a side elevation view of the key switch device in FIG. 3, in which a key top separated from the key switch device;

FIG. 6 is a magnified perspective view of amounting member of the key switch device of the invention;

FIG. 7 is a perspective view of the mounting member shown in FIG. 6 which is assembled to a support plate and a membrane interposed between the mounting member and the support plate;

FIG. 8 is a front elevation view of FIG. 7;

FIG. 9 is a perspective view of the mounting member shown in FIG. 7 holding a rubber switch inserted therein;

FIG. 10 is an exploded perspective view showing the relation between cross-link sections of first and second link members and the mounting member of the key switch device of the invention;

FIG. 11 is a side elevation view of the key switch device of the invention in a parking position;

FIG. 12 is a side elevation view of the key switch device of the invention in an input position; and

FIG. 13 is a perspective view of an alternative to the mounting member of the key switch device of the invention.

### DETAILED DESCRIPTION OF THE PREFERRED EMBODIMENT

The foregoing and other features and advantages of the invention will be fully described and particularly pointed out in the following description and the accompanying drawings.

Herein it is to be understood that the terms “front” and “rear” indicate front and rear in the drawings, the terms “upper” and “lower” indicate upper and lower in the drawings, and other expressions related to positions also describe positions in the drawings.

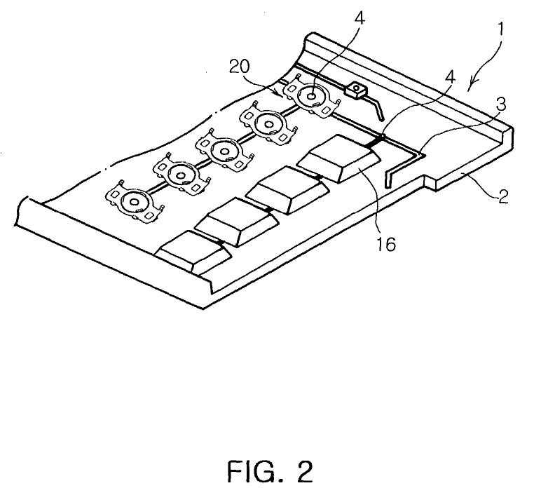

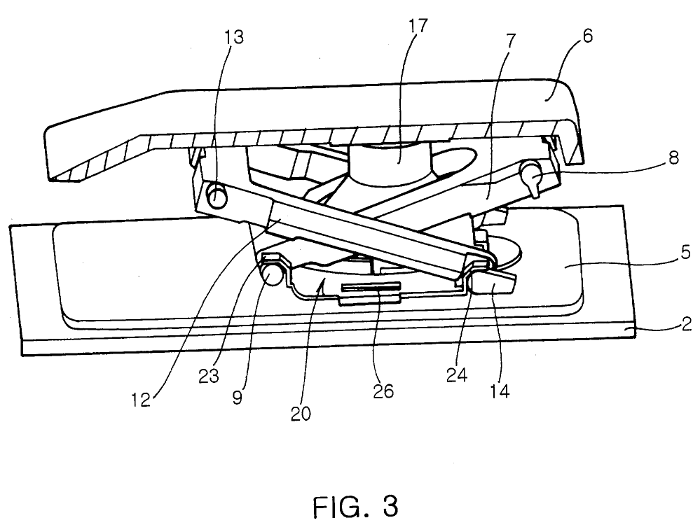

FIG. 2 is a partially exploded perspective view of a keyboard having key switch devices of the invention. As shown in FIG. 2, a keyboard 1 in use for a portable electronic device such as a notebook computer comprises a thin backing board or support plate 2 and a circuit 3 on the support plate 2. The circuit 3 comprises a switch pattern including a number of contact points 4. The support plate 2 is made of a sheet comprising aluminum, steel, stainless steel and so on, and the circuit 3 is printed on an insulation membrane 5 (FIG. 3) of plural layers. An example of the membrane 5 for the circuit 3 is an Np series key switch membrane available from Shunon Electronic in Taiwan.

A number of key tops 6 are arrayed on the support plate 2, respectively, over the contact points 4 so that pressing the key tops 6 is detected by the contact points 4. In FIG. 2, some of the key tops 6 are separated from the support plate 2 to expose some mounting members 20 and the contact points 4 within the exposed mounting members 20.

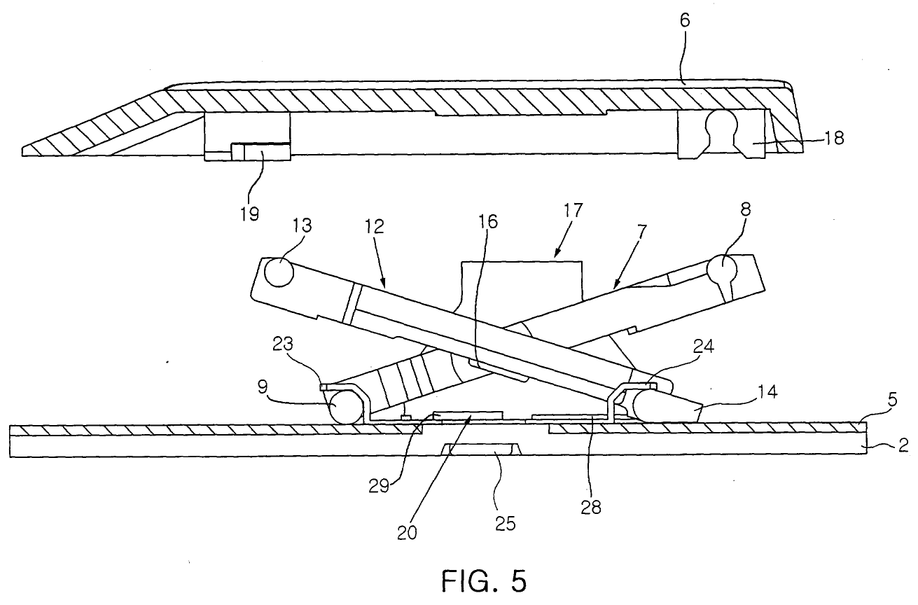

FIGS. 3 to 5 illustrate the overall structure of a key switch device of the invention. Referring to FIGS. 3 to 5, a pair of link members 7 and 12 are cross-linked with each other in a scissor configuration. A mounting member 20 is disposed under the link members 7 and 12 for movably and/or pivotably mounting the link members 7 and 12. An elastic or rubber switch 17 is surrounded by the link members 7 and 12 and the mounting member 20. The rubber switch 17 is provided with a downward protrusion (not shown) in a central lower portion thereof. When a corresponding key top 6 is pressed down as described above, the rubber switch is depressed to push down a contact point 4 so that pressing of the key top 6 is detected. That is, the rubber switch 17 cooperates with the circuit having the contact point 4 to switch an input signal.

The first link member 7 has upper shafts 8, which are pivotably received respectively in vertical receiver portions 18 of the key top 6, and lower shafts 9, which are pivotably coupled respectively with front projections 23 of the mounting member 20. The second link member 12 has upper shafts 13, which are pivotably received respectively in horizontal receiver portions 19 of the key top 6, and lower shafts 14, which are movably coupled with rear projections 24 of the mounting member 20. Therefore, the front and rear projections 23 and 24 function as fixing portions for movably and/or pivotably fixing the lower shafts 9 and 14 of the first and second link members 7 and 12.

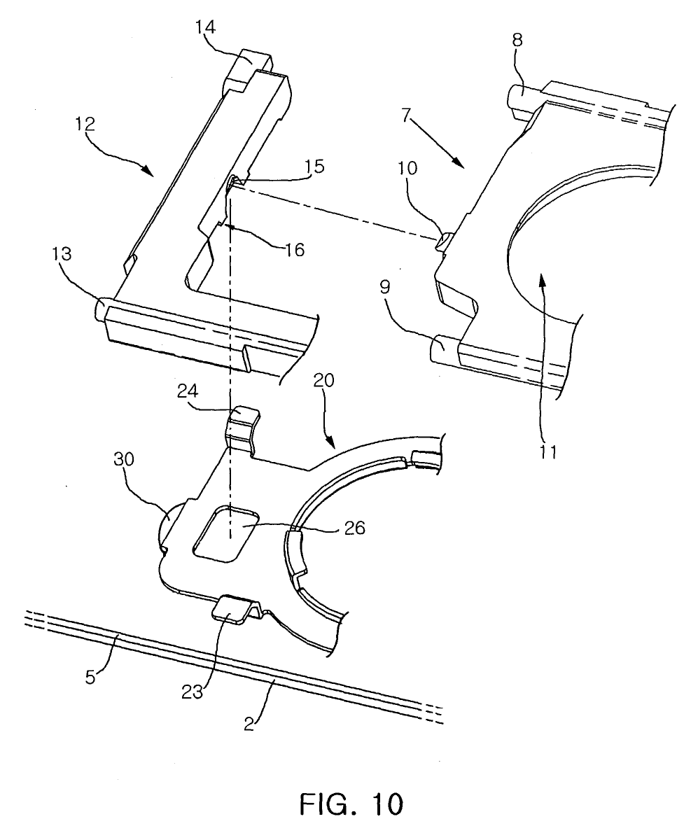

In the meantime, as shown in FIG. 10, the first link member 7 has fulcrums 10 (only one is shown) and the second link member 12 has lever pits 15 (only one is shown) to form cross-link sections together with the fulcrums 10. As the first and second link members 7 are hingeably coupled with each other, the fulcrums 10 are rotatably inserted into the lever pits 15 so that the first and second link members 7 hinge on each other like scissors. According to the above structure of cross-link sections, the first and second link members 7 and 12 perform scissor-like mutual motion to function as a guide member for vertically shifting the overlying key top 6.

In the meantime, the first link member 7 has a guide opening 11 of a diameter larger than the outer diameter of the rubber switch 17 so that the first link member 7 performs hinge motion with the second link member 12 without being interrupted by the rubber switch 17 when the first link member 7 is coupled with the second link member 12 within the second link member 12.

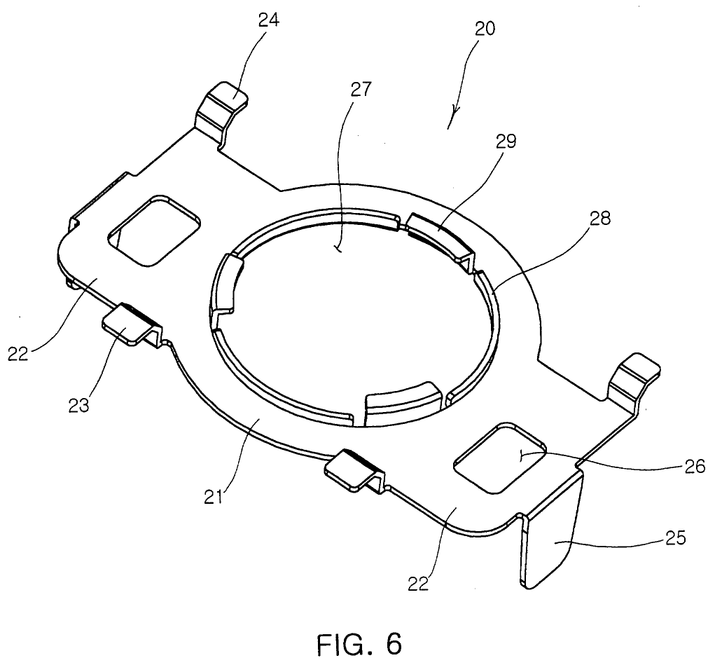

FIG. 6 is an exploded perspective view of the mounting member 20. Referring to FIG. 6, the mounting member 20 has a body 21 in the shape of a substantially flat annular frame and a pair of wings 22 extended laterally from the body 21.

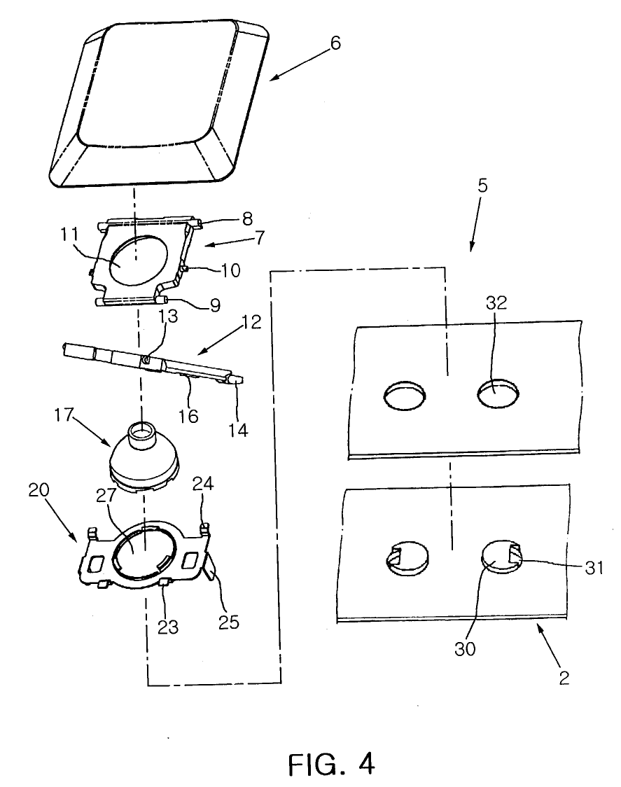

The mounting member also has front projections 23 extended from front regions of the wings 22 and rear projections 24 extended from rear regions of the wings 22. Each of the front projections 23 is projected upward from a front region of each wing 22 adjacent to the body 21 and then folded forward to movably and/or pivotably receive a corresponding one of the lower shafts 9 of the first link member 7 as above-described in reference to FIGS. 3 and 4. Each of the rear projections 24 is projected upward from a rear region of each wing 22 remote from the body 21 and then folded backward to movably and/or pivotably receive a corresponding one of the lower shafts 14 of the second link member 12 as above-described in reference to FIGS. 3 and 4.

Fastening portions 25 are formed respectively at ends of the wings 22, and substantially rectangular lateral openings 26 are formed respectively between the fastening portions 25 and the body 21.

A circular central opening 27 is formed in a central portion of the body 21, and has an inner diameter which is equal or slightly larger than the outer diameter of the rubber switch 17. Three first flanges 28 are formed around the central opening 27, and three second flanges 29 are also formed around the central opening 27, alternating with the first three flanges 28. The first flanges 28 are vertically projected upward around the central opening 27 from the body 21, and the second flanges 29 are vertically projected around the central opening 27 from the body and then folded toward the center of the central hole 27. The second flanges 28 have a height larger than that of the first flanges 28, and each of the first and second flanges 28 and 29 is spaced from adjacent flanges 28 or 29 to a predetermined gap.

The mounting member 20 is made of a sheet of iron or iron alloy, and preferably made of high strength material such as stainless steel.

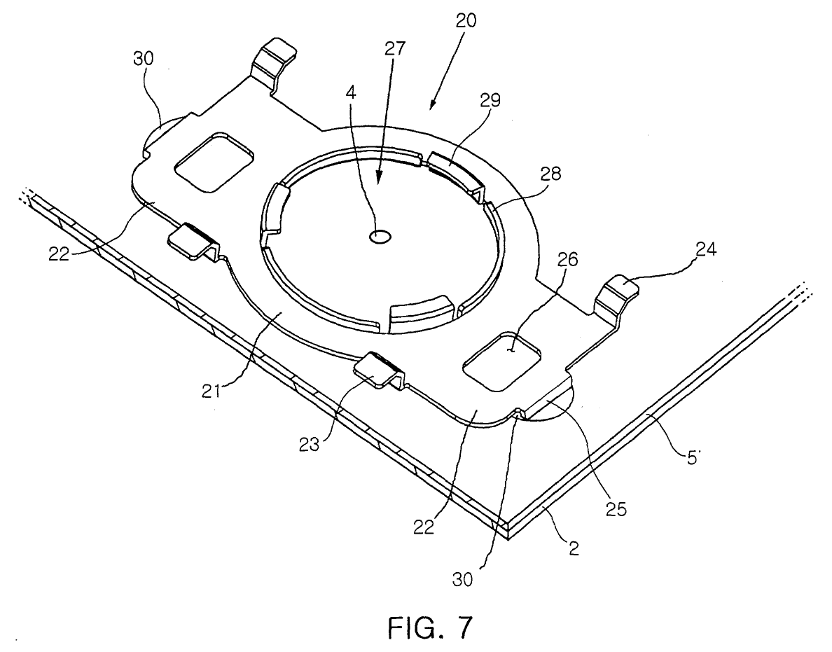

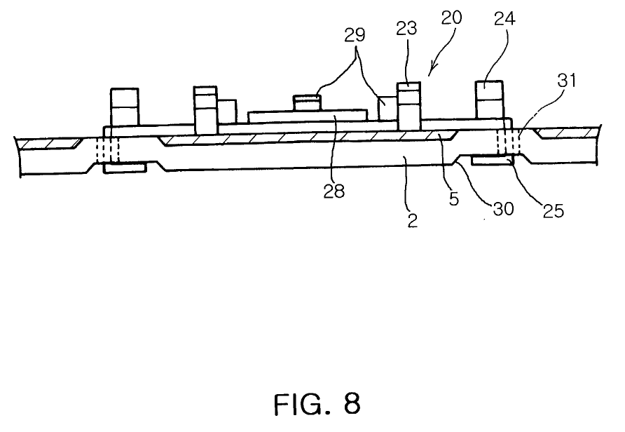

FIG. 7 is a perspective view of the mounting member 20 which is assembled to the support plate 2 and the membrane 5 interposed between the mounting member 20 and the support plate 2, and FIG. 8 is a front elevation view of FIG. 7.

Referring to FIG. 4 again together with FIGS. 7 and 8, the support plate 2 has a pair of upward embossments 30 of a predetermined diameter and substantially rectangular through holes 31 formed in the embossments 30. The membrane 5 has openings 32 in positions corresponding to the embossments 30, in which the diameter of the openings 32 is at least same as the outer diameter of the embossments 30 of the support plate 2. Therefore, attaching the membrane 5 on the support plate 2 causes the openings 32 in the membrane 5 to receive the embossments 30 in the support plate 2. The openings 32 are preferably sized to receive the embossments 30 in tight-fit relation.

As the membrane 5 is attached to the support plate 2 in such a configuration, the embossments 30 in the support plate 2 and the through holes 31 in the embossments 30 are exposed to the upside.

In the meantime, the fastening portions 25 of the mounting member 20 are pushed into the through holes 31 of the support plate 2 and then folded inward as shown in FIG. 8 to assemble the mounting member 20 to the support plate 2. Then, folded portions of the fastening portions 25 are securely fastened with depressions in the underside of the support plate 2 opposite to convex upper portions of the embossments 30 so that the mounting member 20 is securely coupled with the support plate 2 interposing the membrane 5 therebetween.

In the membrane 5 coupled as above, the contact point 4 printed on the membrane 5 is exposed to the outside through the central opening 27 of the mounting member 20.

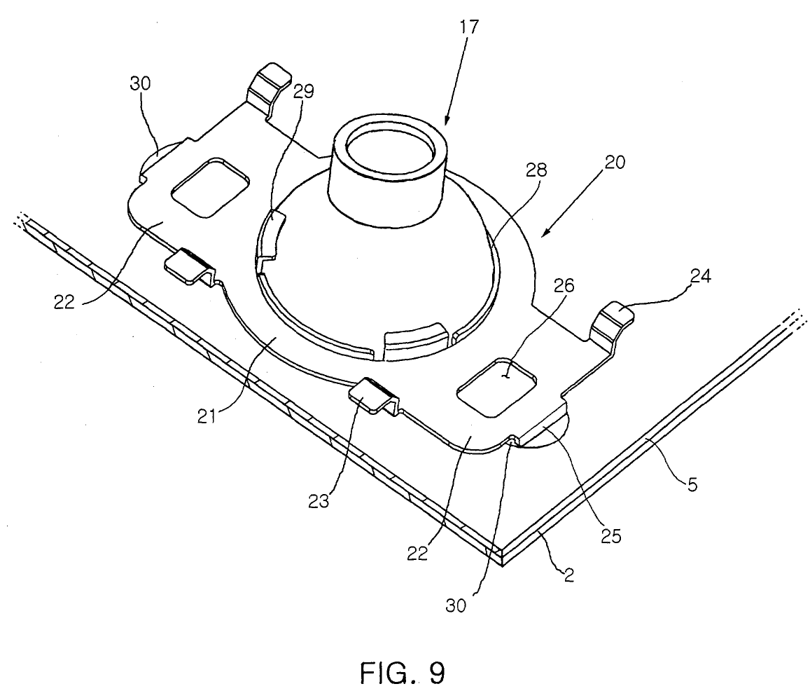

FIG. 9 is a perspective view of the mounting member 20 holding the rubber switch 17 inserted therein. Referring to FIG. 4 again, the rubber switch 17 is shaped as a conical frustum and has a lower end enlarged in diameter in the form of a flange. Inserting the rubber switch 17 of this shape into the central opening 27 of the mounting member 20 causes the enlarged lower end of the rubber switch 17 to be placed within the central opening 27 as shown in FIG. 9. Then, the first flanges 28 of the mounting member 29 guides the rubber switch 17 while contacting the outer periphery of the lower end of the rubber switch 17, and the inward folded portions of the second flanges contact the lower end of the rubber switch 17 from the upside. With this configuration, the central opening 27 and the first and second flanges 28 and 29 function as means for maintaining the rubber switch 17 in position.

In the meantime, the common inner diameter of the first and second flanges 28 and 29 is equal to or slightly larger than the outer diameter of the lower end of the rubber switch 17. Preferably, the first and second flanges 28 and 29 are sized to closely contact the lower end of the rubber switch 17. Further, the inward folded portions of the second flanges 29 are preferably in close contact with an upper portion of the lower end of the rubber switch 17.

It is generally inexpensive to fabricate the rubber switch 17 as a piece separate from the underlying membrane 5. The inner downward projection (not shown) of the rubber switch 17 presses the contact point 4 of the membrane 5 to transmit input operation of the key switch device to an electronic device (not shown), However, the downward projection of the rubber switch 17 is rarely aligned with the contact point unless the rubber switch 17 is fixed in relation to the membrane 5. As a result, the input operation of the key switch device may not be properly transmitted.

In order to prevent malfunction of the key switch device, the rubber switch 17 is fabricated integral with the membrane 5. However, this process consumes relatively high cost. Further, although the rubber switch 17 can be adhered to the membrane 5, this fabrication process requires an additional step of adhering a number of rubber switches to the membrane 5, and thus additional time and cost.

Alternatively, the guide opening 11 is provided in the first link member 7 as set forth above to maintain the rubber switch 17 in position. However, because the guide opening 11 mainly functions to prevent the rubber switch 17 from interfering with motion of the first link member 7 and the rubber switch 17 is spaced from the opening 11 to a predetermined gap, the guide opening structure does not suitably function to maintain the rubber switch 17 in position.

However, as described above, the invention provides the mounting member 20 with the central opening 27 and the first and second flanges 28 and 29, thereby realizing suitable means for maintaining the rubber switch 17 in position even though the rubber switch 17 is fabricated separate from the membrane 5.

Even in the above construction, the rubber switch 17 is typically made of flexible material such as resin so that the rubber switch 17 can be easily inserted into the central opening 27 of the mounting member 20.

FIG. 10 is an exploded perspective view showing the relation between cross-link sections of first and second link members 7 and 12 and the mounting member 20 of the key switch device of the invention. Referring to FIG. 10, each of the lever pits 15 of the second link member 12 receives each of the fulcrums 10 of the first link member 7 to constitute a cross-link section thereby to enable hinge motion between the first and second link members 7 and 12.

As the first and second link members 7 and 14 are hinged in respect to each other, the cross-link section is under a certain amount of force. In order to endure the force, the cross-link section including the fulcrum 10 of the first link member 7 and the lever pit 15 of the second link member 12 needs a predetermined degree of strength.

There are two methods to obtain the above required strength.

First, the first and second link members 7 and 8 including the fulcrums 10 and the lever pits 15 can be made of high strength material to realize a rigid cross-link section so that the cross-link sections can stably perform their function even under a relatively large external force.

However, high strength material generally comprises relatively heavy material such as metal and composite thereof, and heavy material is rarely desirable for elements of the portable electronic device such as a notebook which requires light weight.

Second, the first and second link members 7 and 12 can be made thicker to obtain the strength required of the first and second link members 7 and 12.

However, thick link members 7 and 12 increase the volume of the entire key switch device, and thus this method is also not desirable with regard to the current tendency that the portable electronic device is getting gradually thinner.

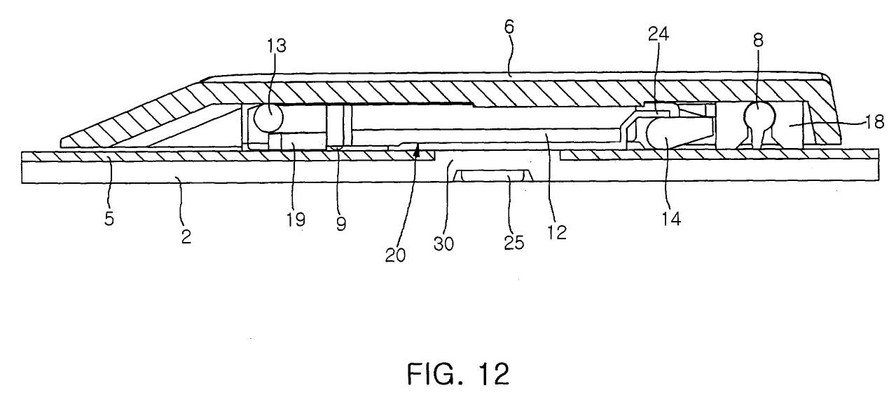

In order to overcome the above problem, the invention provides thick portions 16 (only one is shown) to the second link member 12 and the lateral openings 26 to the mounting member 20 in positions corresponding to the thick portions 16. Resulting from formation of the thick portions 16 in the second link member 12 like this, a predetermined amount of strength required for regions around the lever pits 15 can be readily obtained without increasing the thickness of the entire second link member 12. Further, the thick portions 16 are inserted into the lateral openings 26 of the lower mounting member 20 when the key top 6 is pressed down as shown in FIG. 12 so as to reduce the height of the entire key switch device.

The above configured first and second link members 7 and 12 are illustrated desirable in the key switch device of the invention, but is not to be construed as the limit of the invention. The key switch device of the invention can adopt various shapes of link members including the first and second link members used in the conventional art.

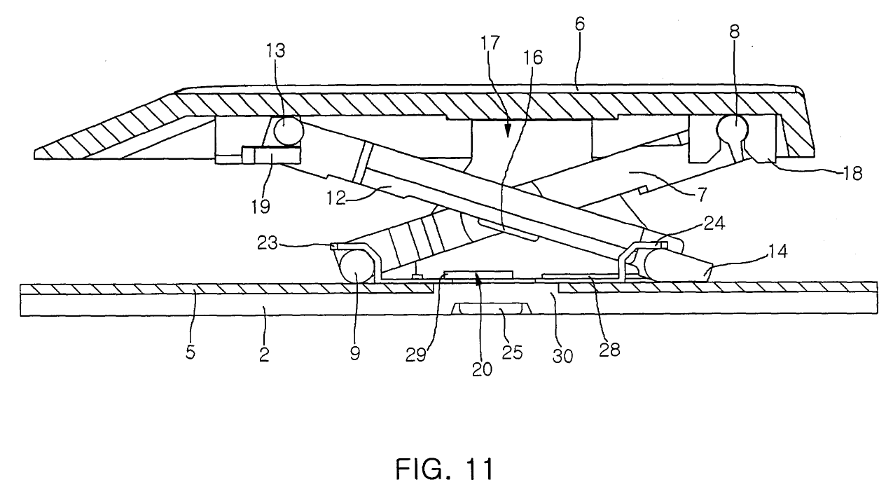

FIG. 11 is a side elevation view of the key switch device of the invention in a parking position, and FIG. 12 is a side elevation view of the key switch device of the invention in an input position.

In the key switch device in the parking position shown in FIG. 11, the upper shafts 8 of the first link member 7 are placed in the vertical receiver portions 18 of the key top 6 and the upper shafts 13 of the second link member 12 are placed on the horizontal receiver portions 19 of the key top 6.

When a user presses the key switch device with a finger from the parking position in FIG. 11 to the input position in FIG. 12, the upper shafts 8 of the first link member 7 pivot in the vertical receiver portions 18 of the key top 6, and the upper shafts 13 of the second link member 12 move inward on the horizontal receiver portions 19 of the key top 6. The first and second link members 7 and 12 pivot about the cross-link sections of the fulcrums 10 and the lever pits 15 like scissors so that the entire key switch device has a depressed flat configuration.

When the first and second link members 7 and 12 pivot parallel with each other, the rubber switch 17 within the first and second link members 7 and 12 is accordingly depressed and the inner lower projection (not shown) presses the contact point 4 in the membrane 5 so that the input operation via the key switch device can be transmitted to a controller such as a CPU (not shown).

As the user detaches the finger, the rubber switch 17 returns from this position to the original position based upon its own elasticity. Then, the first and second link members 7 move to a crossed position from the parallel position and the key switch device also returns to the position in FIG. 11.

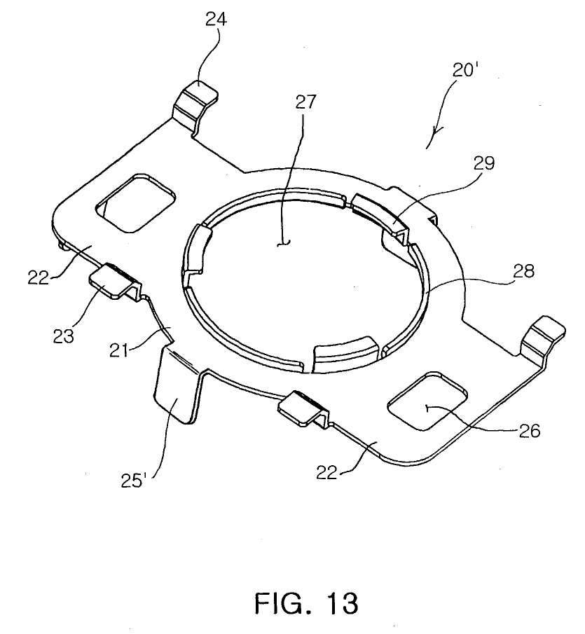

FIG. 13 is a perspective view of an alternative to the mounting member of the key switch device of the invention. Referring to FIG. 13, the alternative mounting member 20′ of the key switching device of the invention is substantially equal to the mounting member 20 in FIG. 6 except that a pair of fastening portions 25 are extended downward from front and rear regions of a body 21. Since the alternative mounting member 20′ has a structure substantially equal to that of the mounting member 20 except for the fastening portions 25′, further description about same parts will be omitted.

In the meantime, the mounting member 20, 20′ of the invention may be coupled with the membrane 5 instead of the support plate 2. That is, the openings 32 of the membrane 5 in FIG. 4 can be formed in such a size sufficient only for receiving the fastening portions 25, 25′. Then, the fastening portions 25, 25′ are inserted into the membrane openings 32 and folded to assemble the mounting member 20, 20′ to the membrane 5.

It is necessary for the membrane 5 to have a predetermined strength in order to directly support the mounting member 20, 20′. Then, the thickness of the membrane 5 should be increased to obtain the necessary strength. However, thickness increase is not desirable since it also increases the thickness of the key switch device and the portable electronic device having the key switching device.

Also, where the mounting member 20, 20′ is fixed to the membrane 5, pressing the key switch device applies a certain pressure to the membrane 5 so that the whole membrane 5 may wobble causing the contact 4 unstable. This may disadvantageously cause malfunction to the sensitive contact point 4.

The above key switch device of the invention is applied to a keyboard of the portable electronic device such as a notebook computer, which comprises a Liquid Crystal Display (LCD), a CPU, a storage unit for storing a plurality of programs, a board mounted with various elements for processing operations according to the programs, a power supply and the keyboard having a plurality of the key switch devices.

The portable electronic device receives a signal inputted via the operation of the key switch device, displays the signal via the LCD, and then executes a necessary program under the control of the CPU.

The following description will present a fabrication process of the key switch device of the invention.

First, a first sheet comprising a material such as stainless steel having a predetermined strength is prepared and then formed into a mounting member with a suitable apparatus such as a die press.

A second sheet comprising a material of a predetermined strength such as iron, steel and stainless steel is cut into a shape required for a keyboard, in which the second sheet has a predetermined thickness larger than that of the first sheet.

A desired number of through holes are perforated in the second sheet with a die press and the like. An equal number of embossments are formed around the through holes to form a support board. Herein the order of forming the through holes and the embossments may be reversed.

Then, a membrane printed with a switching circuit necessary for the keyboard is prepared and perforated in positions corresponding to the embossments to form openings in a size equal or slightly larger than that of the embossments.

The perforated membrane is attached over the support plate, and inspection is made to confirm whether the membrane openings properly receive the embossments in the support plate and expose the embossments through the openings.

Then, each mounting member is placed above the openings and fastening portions are inserted through the through holes in the embossments. When the body of the mounting member closely contacts the membrane, the fastening portions are folded and fixedly fastened with the depressions in the underside of the support plate.

Upon assembling the mounting member to the support plate like this, a rubber switch is placed in a central opening of mounting member.

Then, first and second link members and a key top are assembled with the mounting member to complete fabrication of the key switch device of the invention.

In the above fabrication process, the steps of mounting lower shafts of the first and second link members on front and rear projections of the mounting member and inserting upper shafts of the first and second link members into vertical and horizontal receiver portions can be performed according to typical techniques which are well known in the art.

After fabricated as above, the key switch device of the invention can be applied to the above-described portable electronic device.

According to the key switch device of the invention as set forth above, the mounting member for mounting the first and second link members is formed separate from the support plate to impart a simple structure to the support plate. As the mounting member is provided separate from the support plate, the support plate does not need a precise process, which is essential to the prior art, thereby facilitating a fabrication process of the support plate. Moreover, even though the mounting member is broken, the support plate itself is not replaced and thus cost is saved.

Further, the separate mounting member can be made of high strength material such as stainless steel, thereby enhancing the endurance of the mounting member. Unlike the prior art, the support plate also can be made of rigid and inexpensive material rather than aluminum, thereby enhancing the endurance of the support plate while reducing the fabrication cost thereof.

Moreover, the central opening and the first and second flanges of the mounting member are utilized as means for maintaining the rubber switch in position to omit any separate means for maintaining the position of the rubber switch in relation to the membrane. This resultantly simplifies the construction of the key switch device necessary for maintaining the rubber switch and thus potentially reduces the fabrication cost thereof.

Although the preferred embodiments of the present invention have been disclosed for illustrative purposes, it is to be understood by those skilled in the art that various modifications, additions and substitutions can be made without departing from the spirit and scope of the invention as disclosed in the accompanying claims.

What is claimed is:

1. A key switch device for switching a signal as a key top is pressed down, comprising:
first and second link members which are cross-linked with each other to act like scissors;
the key top having receiver portions formed in an underside thereof for movably or pivotably receiving upper shaft pairs each formed at upper ends of each of the first and second link members;
a support plate disposed under the key top and having a plurality of through holes in predetermined positions;
a membrane member disposed on the support plate under the key top, the membrane member having a contact point for contacting an elastic switch as the elastic switch is pressed down by the key top and openings formed around the through holes in the support plate to expose the through holes; and
a mounting member separate from the support plate, the mounting member including fixing portions for movably or pivotably fixing lower shaft pairs each formed at lower ends of the each link member and fastening portions fixedly fastened with an underside of the support plate via the through holes in the support plate.

2. The key switch device as set forth in claim 1, wherein the fastening portions are formed at both lateral regions of the mounting member.

3. The key switch device as set forth in claim 2, wherein the through holes are formed at a gap corresponding to that of the fastening portions.

4. The key switch device as set forth in claim 1, wherein the support plate has embossments which are pressed upward around the through holes.

5. The key switch device as set forth in claim 4, wherein the fastening portions are fastened with the support plate at lower depressions of the embossments.

6. The key switch device as set forth in claim 1, wherein the fastening portions are formed at front and rear regions of the mounting member.

7. The key switch device as set forth in claim 1, wherein the mounting member includes means for maintaining the elastic switch in position, wherein the maintaining means has a central opening for supporting a lower outer periphery of the elastic switch.

8. The key switch device as set forth in claim 7, wherein the maintaining means include a flange which is projected upward from an outer periphery of the central opening.

9. The key switch device as set forth in claim 8, wherein the flange comprises at least one pair of flanges having heights different from each other.

10. The key switch device as set forth in claim 8, wherein the flange comprises a plurality of flanges discontinued from each other.

11. The key switch device as set forth in claim 1, wherein the second link member has a thick portion formed in a portion thereof which is cross-linked with a portion of the first link member, and
wherein the mounting member has an opening in a portion which corresponds to the thick portion when the key top is pressed down.

12. The key switch device as set forth in claim 1, wherein the support plate has embossments which are pressed upward around the through holes, and
wherein the openings of the membrane member are formed in positions corresponding to the upward embossments.

13. A key switch device for switching a signal as a key top is pressed down, comprising:
first and second link members which are cross-linked with each other to act like scissors;
the key top having receiver portions formed in an underside thereof for movably or pivotably receiving upper shaft pairs each formed at upper ends of each of the first and second link members;
a support plate disposed under the key top;
a membrane member disposed on the support plate under the key top and having a contact point;
an elastic switch shaped as a conical frustum, and when pressed down by the key top, contacting by a portion thereof the contact point in the membrane member; and
a mounting member separate from the support plate, the mounting member including fixing portions for movably or pivotably fixing lower shaft pairs each formed at lower ends of the each link member, fastening portions fixedly fastened with the support plate, and means for maintaining the elastic switch in position, wherein the maintaining means has a central opening for supporting a lower outer periphery of the elastic switch.

14. The key switch device as set forth in claim 13, wherein the maintaining means include a flange which is projected upward from an outer periphery of the central opening.

15. The key switch device as set forth in claim 14, wherein the flange comprises at least one pair of flanges having heights different from each other.

16. The key switch device as set forth in claim 14, wherein the flange comprises a plurality of flanges discontinued from each other.

17. The key switch device as set forth in claim 13, wherein the support plate has a plurality of through holes in predetermined positions, and
wherein the fastening portions of the mounting member are fixedly fastened with the underside of the support plate via the through holes in the support plate.

18. The key switch device as set forth in claim 17, wherein the fastening portions are formed at both lateral regions of the mounting member.

19. The key switch device as set forth in claim 17, wherein the through holes are formed at a gap corresponding to that of the fastening portions.

20. The key switch device as set forth in claim 17, wherein the support plate has embossments which are pressed upward around the through holes.

21. The key switch device as set forth in claim 20, wherein the fastening portions are fastened with the support plate at lower depressions of the embossments.

22. The key switch device as set forth in claim 17, wherein the fastening portions are formed at front and rear regions of the mounting member.

23. The key switch device as set forth in claim 17, wherein the support plate has embossments which are pressed upward around the through holes, and
wherein the membrane member has openings formed in positions corresponding to the upward embossments.

24. The key switch device as set forth in claim 13, wherein the second link member has a thick portion formed in a portion thereof which is cross-linked with a portion of the first link member, and
wherein the mounting member has an opening in a portion which corresponds to the thick portion when the key top is pressed down.

25. A portable electronic device comprising: a CPU, a storage unit for storing a plurality of programs, a board mounted with a plurality of components for processing operations according to the programs, a keyboard including a plurality of key switch devices each for switching a signal as a key top is pressed down, a liquid crystal display unit and a power supply, wherein each of the keyboard includes
first and second link members which are cross-linked with each other to act like scissors;
the key top having receiver portions formed in an underside thereof for movably or pivotably receiving upper shaft pairs each formed at upper ends of each of the first and second link members;
a support plate disposed under the key top and having a plurality of through holes in predetermined positions;
a membrane member disposed on the support plate under the key top, the membrane member having a contact point for contacting an elastic switch as the elastic switch is pressed down by the key top and openings formed around the through holes in the support plate to expose the through holes; and
a mounting member separate from the support plate, the mounting member including fixing portions for movably or pivotably fixing lower shaft pairs each formed at lower ends of the each link member and fastening portions fixedly fastened with an underside of the support plate via the through holes in the support plate.

26. A portable electronic device comprising: a CPU, a storage unit for storing a plurality of programs, a board mounted with a plurality of components for processing operations according to the programs, a keyboard including a plurality of key switch devices each for switching a signal as a key top is pressed down, a liquid crystal display unit and a power supply, wherein each of the keyboard includes:
first and second link members which are cross-linked with each other to act like scissors;
the key top having receiver portions formed in an underside thereof for movably or pivotably receiving upper shaft pairs each formed at upper ends of each of the first and second link members;
a support plate disposed under the key top;
a membrane member disposed on the support plate under the key top and having a contact point;
an elastic switch shaped as a conical frustum, and when pressed down by the key top, contacting by a portion thereof the contact point in the membrane member; and
a mounting member separate from the support plate, the mounting member including fixing portions for movably or pivotably fixing lower shaft pairs each formed at lower ends of the each link member, fastening portions fixedly fastened with the support plate, and means for maintaining the elastic switch in position, wherein the maintaining means has a central opening for supporting a lower outer periphery of the elastic switch.
